(19) United States
(12) Patent Application Publication
(10) Pub. No.: US 2022/0305435 A1
(43) Pub. Date: Sep. 29, 2022

(54) GAS CONCENTRATING METHOD AND GAS CONCENTRATING DEVICE

(71) Applicant: HONDA MOTOR CO., LTD., Tokyo (JP)

(72) Inventors: Yoshinori Tsurugai, Wako-shi (JP); Masaya Igaki, Wako-shi (JP); Yuki Aiba, Wako-shi (JP); Phuong tu Mai, Wako-shi (JP)

(21) Appl. No.: 17/590,846

(22) Filed: Feb. 2, 2022

(30) Foreign Application Priority Data
Mar. 26, 2021 (JP) 2021-053824

(51) Int. Cl. B01D 53/22; B01D 53/30; C01B 32/50

(52) U.S. Cl. CPC B01D 53/226; B01D 53/30; C01B 32/50

(57) ABSTRACT

A gas concentrating method and a gas concentrating device in which a large-capacity storage tank is not required and power consumption can be minimized are provided. A gas concentrating device (100) which concentrates a target gas including: a gas separating membrane module (3) including a gas separating membrane (1) and an accommodating container (2), a gas supply line (L1) through which a first mixed gas (G1) containing a target gas is supplied to the gas separating membrane module (3), a gas recovery line (L2) through which a second mixed gas (G2) containing a target gas is taken out from the gas separating membrane module (3), a gas discharge line (L3) through which an exhaust gas (G3) is discharged from the gas separating membrane module (3), and a raw material line (L0) through which a raw material (G0) to supplied to the gas supply line (L1), in which the raw material (G0) through the raw material line (L0) and the second mixed gas (G2) through the gas recovery line (L2) are supplied to the gas supply line (L1) and a gas concentrating method are provided.

This application claims priority from Japanese Patent Application No. 2021-053824, filed on Mar. 26, 2021, the content of which is incorporated herein by reference.

### BACKGROUND OF THE INVENTION

### Field of the Invention

The present invention relates to a gas concentrating method and a gas concentrating device.

### Description of Related Art

In the related art, methods and devices for concentrating a target gas such as carbon dioxide (CO₂) are known.

JP 2020-195968A (Patent Document 1) describes a CO₂ concentrating method and a CO₂ concentrating device including a first collecting step of depressurizing a second side in a state in which a first side is exposed to a gas having a first CO₂ concentration under an atmospheric pressure environment and collecting a CO₂-rich gas which has flowed from the first side to the second side through a CO₂ separating membrane and has been depressurized and which has a second CO₂ concentration higher than the first CO₂ concentration in a first collector, a transferring step of transferring the collected CO₂-rich gas to a second collector, and a second collecting step of collecting a CO₂-rich gas having a pressure near atmospheric pressure in a second collector by repeatedly performing the first collecting step and the transferring step a plurality of times.

### SUMMARY OF THE INVENTION

In a gas concentrating device using a gas separating membrane in the related art, there are points which can be improved such as an increase in scale of a device due to the need for a large-capacity storage tank and an increase in power consumption due to an increase in pump operating time of a gas concentrating device.

An object of the present invention is to provide a gas concentrating method and a gas concentrating device in which a large-capacity storage tank is not required and thus power consumption can be minimized

The present invention adopts the following aspects.

(1) A gas concentrating method in an embodiment is a gas concentrating method which concentrates a target gas using a gas separating membrane which separates a first side and a second side including: a first step of supplying a first mixed gas (target gas concentration: X₀ mol %) containing the target gas to the first side of the gas separating membrane and passing the first mixed gas through the gas separating membrane to generate a second mixed gas (target gas concentration: Y₀ mol %, Y₀>X₀) containing the target gas on the second side; and a second step of mixing the second mixed gas with a raw gas, supplying a new first mixed gas (target gas concentration: X₁ mol %) containing the target gas to the first side of the gas separating membrane, and passing the new first mixed gas through the gas separating membrane to generate a new second mixed gas (target gas concentration: Y₁ mol %) containing the target gas on the second side, wherein the second step is repeatedly performed.

In the gas concentrating method in the embodiment, when the gas having the increased target gas concentration is recovered and repeatedly supplied to the primary side of the gas separating membrane, it is possible to further increase the target gas concentration in the mixed gas.

(2) An amount of supply A [mL/min] of the first mixed gas and a target gas concentration X [mol %] in the first mixed gas and an amount of generation B [mL/min] of the second mixed gas and a target gas concentration Y [mol %] in the second mixed gas may be monitored over time, and if a rate of change in target gas concentration in the second mixed gas is less than or equal to a prescribed value, an amount of supply of the first mixed gas in the second step may be decreased and the target gas concentration in the second mixed gas may be increased.

Although the increase in the target gas concentration in the second mixed gas eventually reaches a plateau, when these conditions are set and the conditions are satisfied, it is possible to further increase the target gas concentration in the second mixed gas by reducing the amount of supply of the first mixed gas.

(3) The target gas may be carbon dioxide and the raw material may be the atmosphere.

(4) A gas concentrating device (for example, a gas concentrating device 100) in an embodiment includes: a gas separating membrane module (for example, a gas separating membrane module 3) including a gas separating membrane (for example, a gas separating membrane 1) and an accommodating container (for example, an accommodating container 2), a gas supply line (for example, a gas supply line L1) through which a first mixed gas containing a target gas is supplied to the gas separating membrane module, a gas recovery line (for example, a gas recovery line L2) through which a second mixed gas containing a target gas is taken out from the gas separating membrane module, a gas discharge line (for example, a gas discharge line L3) through which an exhaust gas is discharged from the gas separating membrane module, and a raw material line (for example, a raw material line L0) through which a raw material is supplied to the gas supply line, wherein the raw material through the raw material line and the second mixed gas through the gas recovery line are supplied to the gas supply line.

(5) The gas concentrating device may further include: a monitoring device (for example, a monitoring device M) which monitors an amount of supply A [mL/min] of the first mixed gas and a target gas concentration X [mol %] in the first mixed gas and an amount of generation B [mL/min] of the second mixed gas and a target gas concentration Y [mol %] in the second mixed gas over time; and a flow rate control device which controls an amount of supply of the first mixed gas, wherein, if a rate of change in target gas concentration in the second mixed gas is less than or equal to a prescribed value, an instruction is given to decrease the amount of supply of the first mixed gas in the second step.

(6) The target gas may be carbon dioxide and the raw material may be the atmosphere.

According to the aspects of (1) to (6), it is possible to provide a gas concentrating method and gas concentrating device in which a large-capacity storage tank is not required and thus power consumption can be minimized

### BRIEF DESCRIPTION OF THE DRAWINGS

FIG. 1 is a block diagram showing a carbon dioxide treatment device according to an embodiment.

FIGS. 2A and 2B are schematic diagrams showing a gas concentrating device according to a modified example, FIG. 2A is an example in which a storage tank is disposed on a passing gas path, and FIG. 2B is an example in which the storage tank is installed in an exhaust gas outlet.

FIG. 3 is a graph showing a relationship between a time from the start of operation and a CO₂ concentration in a second mixed gas when the gas concentrating device in the embodiment is used.

FIG. 4 is a schematic diagram showing a gas concentrating device in the related art.

FIG. 5 is a graph showing a relationship between a time from the start of operation and a CO₂ concentration in a gas which has passed through a gas exchange membrane when the gas concentrating device in the related art is used.

### DETAILED DESCRIPTION OF THE INVENTION

Embodiments of the present invention will be described below with reference to the drawings. The dimensions and the like of the drawings exemplified in the following description are examples, the present invention is not necessarily limited to them, and the present invention can be appropriately modified without changing the gist of the present invention.

[Gas concentrating method]

A gas concentrating method in an embodiment is a gas concentrating method for concentrating a target gas using a gas separating membrane which separates a first side and a second side including a first step of supplying a first mixed gas (target gas concentration: X₀ mol %) containing a target gas to a first side of the gas separating membrane and generating a second mixed gas (target gas concentration: Y₀ mol %, Y₀>X₀) containing a target gas on the second side by passing the target gas through the gas separating membrane, and a second step of mixing the second mixed gas with a raw material, supplying a new first mixed gas (target gas concentration: X₁ mol %) containing a target gas to a first side of the gas separating membrane, and generating a new second mixed gas (target gas concentration: Y₁ mol %) containing a target gas on the second side by passing the target gas through the gas separating membrane, in which the second step is repeatedly performed.

The first mixed gas in the first step is, for example, a raw material, whereas the first mixed gas (new first mixed gas) in the second step is a mixed gas obtained by mixing the second mixed gas and the raw material.

In the first step and the second step, when the first side of the gas separating membrane is pressurized or the second side thereof is depressurized, the separation of the target gas from the first mixed gas is promoted.

When the second step is repeatedly performed, the target gas concentration in the second mixed gas increases, but eventually a rate of change of the target gas concentration to a time approaches zero and an increase in target gas concentration reaches a plateau. On the other hand, if an amount of supply A [mL/min] of the first mixed gas and a target gas concentration X [mol %] in the first mixed gas and an amount of generation B [mL/min] of the second mixed gas and a target gas concentration Y [mol %] in the second mixed gas over time be monitored and the rate of change of the target gas concentration in the second mixed gas is less than or equal to a prescribed value, it is preferable to reduce the amount of supply of the first mixed gas and increase the target gas concentration in the second mixed gas.

Although the target gas and the raw material are not particularly limited, for example, it is preferable that the target gas be carbon dioxide and the raw material be the atmosphere (air).

The concentrated carbon dioxide can be reduced, for example, using an electrochemical reaction to produce an industrially useful monomer such as ethylene.

[Gas concentrating device]

A gas concentrating device in the embodiment will be described with reference to the drawings as appropriate.

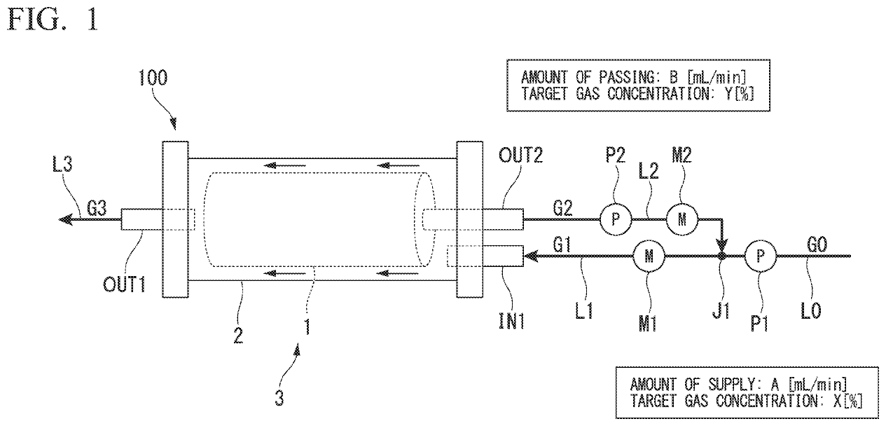

A gas concentrating device 100 shown in FIG. 1 includes a gas separating membrane module 3 including a gas separating membrane 1 and an accommodating container 2, a gas supply line L1 through which a first mixed gas G1 containing a target gas is supplied to the gas separating membrane module 3, a gas recovery line L2 through which a second mixed gas G2 containing a target gas is taken from the gas separating membrane module 3, a gas discharge line L3 through which an exhaust gas G3 after separating the second mixed gas G2 from the first mixed gas G1 is discharged from the gas separating membrane module 3, and a raw material line L0 through which a raw material G0 is supplied to the gas supply line L1.

The gas supply line L1 is connected to the raw material line L0 and the gas recovery line L2 at a connection point J1. In addition, the raw material G0 is supplied through the raw material line L0 and the second mixed gas G2 is supplied through the gas recovery line L2 so that the raw material G0 is mixed with the second mixed gas G2.

When a primary side of the gas separating membrane (a side to which the first mixed gas G1 is supplied) is pressurized and a secondary side thereof (a side on which the second mixed gas G2 is generated) is depressurized, separation of the target gas from the first mixed gas is promoted. In the gas concentrating device 100, the pressurization and depressurization of the gas can be performed by, for example, pumps P1 and P2.

When an operation of the gas concentrating device 100 is continued, if a countermeasure is not applied, a target gas concentration Y in the second mixed gas G2 will eventually reach a plateau. As a countermeasure, it is preferable to further provide monitoring devices M1 and M2 which monitor an amount of supply A [mL/min] of the first mixed gas G1 and the target gas concentration X [mol %] in the first mixed gas G1 and an amount of generation B [mL/min] of the second mixed gas G2 and the target gas concentration Y [mol %] in the second mixed gas G2 over time, a flow rate control device (pump P1) which controls an amount of supply of the first mixed gas G1, and the pump P2 which adjusts a flow rate of the second mixed gas G2 if desired. In this case, if the rate of change of the target gas concentration in the second mixed gas G2 is less than or equal to a prescribed value, it is preferable to perform setting to provide an instruction so that the amount of supply of the first mixed gas G1 decreases.

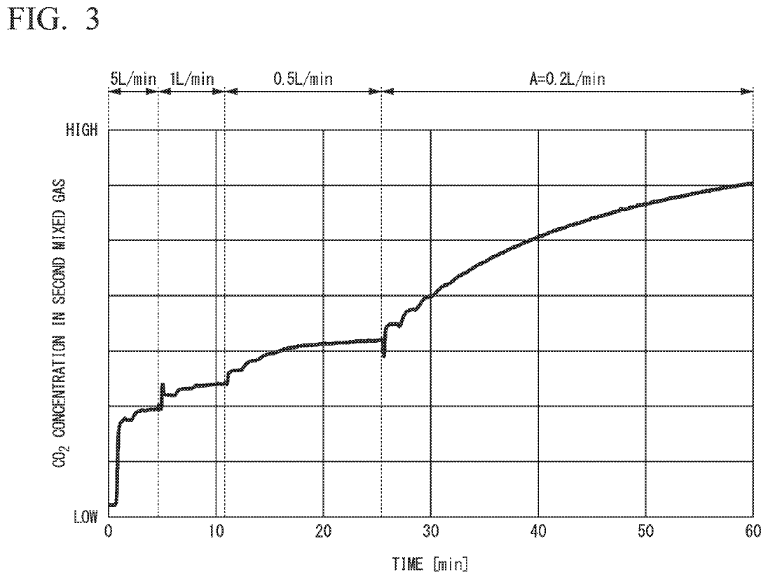

FIG. 3 shows a graph showing a relationship between time and a carbon dioxide (CO₂) concentration in the second mixed gas when carbon dioxide is concentrated using the atmosphere as the raw material G0 using the gas concentrating device 100 in the embodiment.

First, although a flow rate A of the first mixed gas is set to 5 L/min, an increase in carbon dioxide concentration in the second mixed gas reaches a plateau after nearly 4 minutes. Thus, when the flow rate A of the first mixed gas is lowered to 1 L/min, the carbon dioxide concentration in the second mixed gas is started to increase again. After that, when the flow rate A of the first mixed gas is lowered every time the increase in carbon dioxide concentration in the second mixed gas reaches a plateau, each time the increase in carbon dioxide concentration in the second mixed gas is started to increase again.

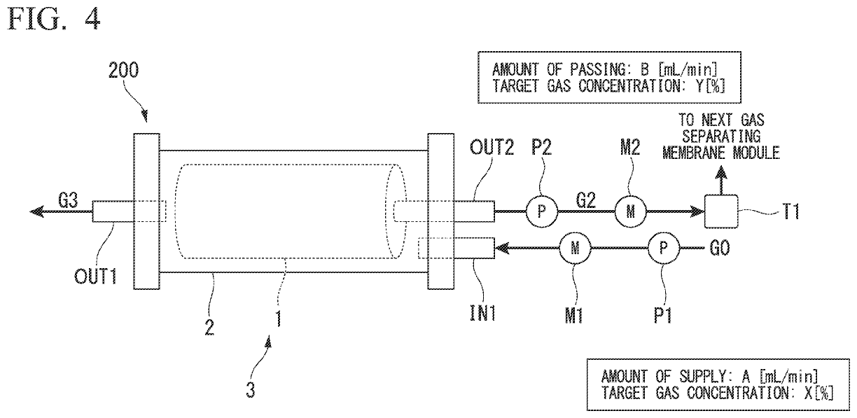

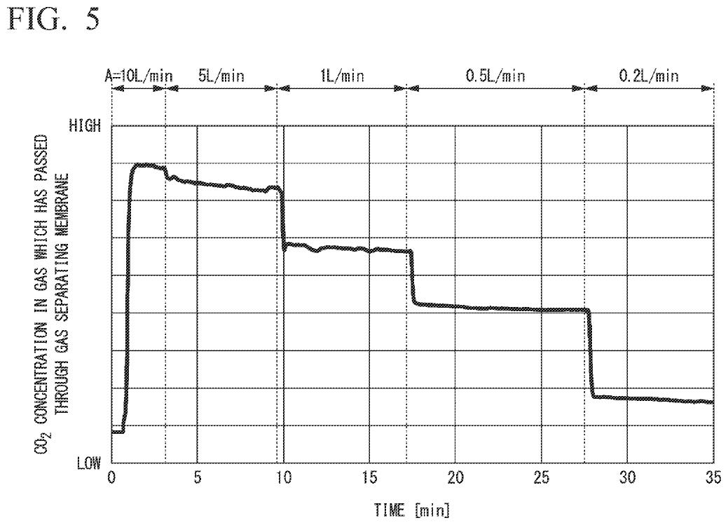

FIG. 5 shows a graph showing a relationship between a flow rate of a raw material and a carbon dioxide concentration in a gas which has passed through a gas separating membrane when carbon dioxide is concentrated using the atmosphere as the raw material using a gas concentrating device 200 in the related art shown in FIG. 4. Although the carbon dioxide concentration in the second mixed gas is started to decrease and then a flow rate A of the raw material is lowered, the carbon dioxide concentration in the second mixed gas is lowered without started to increase.

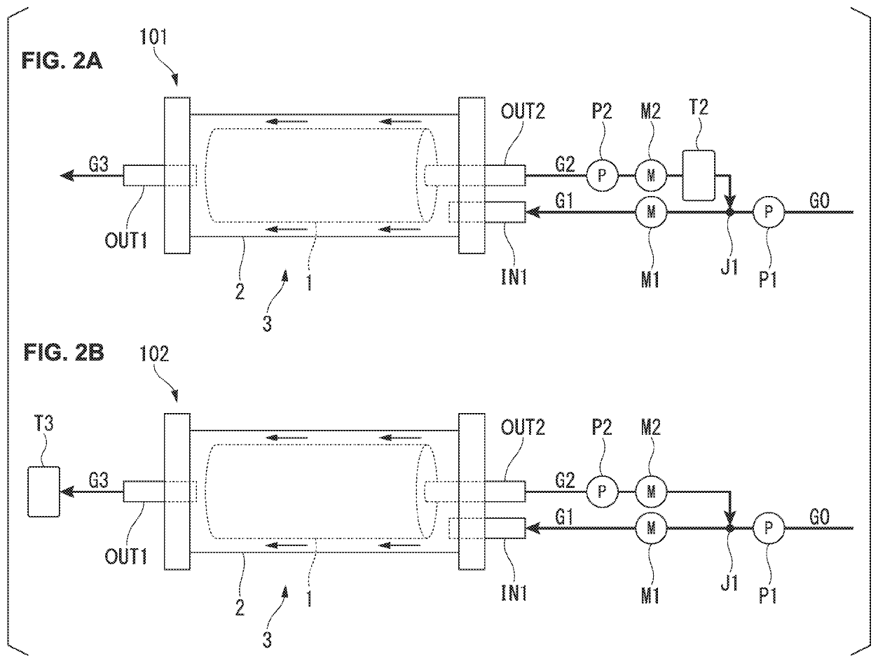

FIGS. 2A and 2B show modified examples of the gas concentrating device 100 in the embodiment.

A gas concentrating device 101 shown in FIG. 2A is included in the modified example in which a storage tank T2 is installed at a certain place of a gas recovery line L2. In this modified example, a gas having a higher target gas concentration can be obtained.

A gas concentrating device 102 shown in FIG. 2B is included in the modified example in which a storage tank T3 is installed in an exhaust line L3. In this modified example, a gas having a target gas concentrated therein can be continuously recovered.

In the gas concentrating device 100 in the embodiment, it is preferable that the target gas be carbon dioxide and a raw material be the atmosphere.

The concentrated carbon dioxide can be reduced by an electrochemical reaction to be used as the raw material for producing an industrially useful carbon compound such as ethylene.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

1 Gas separating membrane

2 Accommodating container

3 Gas separating membrane module

100, 101, 102, 200 Gas concentrating device

OUT1 Exhaust gas outlet

OUT2 Passing gas outlet

IN1 Raw material inlet

G0 Raw material

G1 First mixed gas

G2 Second mixed gas

G3 Exhaust gas

L0 Raw material line

L1 Gas supply line

L2 Gas recovery line

L3 Gas discharge line

T1 Storage tank

T2, T3 Storage tank

What is claimed is:

1. A gas concentrating method which concentrates a target gas using a gas separating membrane which separates a first side and a second side, comprising:
a first step of supplying a first mixed gas (target gas concentration: X₀ mol %) containing the target gas to the first side of the gas separating membrane and passing the first mixed gas through the gas separating membrane to generate a second mixed gas (target gas concentration: Y₀ mol %, Y₀>X₀) containing the target gas on the second side; and
a second step of mixing the second mixed gas with a raw gas, supplying a new first mixed gas (target gas concentration: X₁ mol %) containing the target gas to the first side of the gas separating membrane, and passing the new first mixed gas through the gas separating membrane to generate a new second mixed gas (target gas concentration: Y₁ mol %) containing the target gas on the second side,
wherein the second step is repeatedly performed.

2. The gas concentrating method according to claim 1, wherein an amount of supply A [mL/min] of the first mixed gas and a target gas concentration X [mol %] in the first mixed gas and an amount of generation B [mL/min] of the second mixed gas and a target gas concentration Y [mol %] in the second mixed gas are monitored over time, and
if a rate of change in target gas concentration in the second mixed gas is less than or equal to a prescribed value, an amount of supply of the first mixed gas in the second step is decreased and the target gas concentration in the second mixed gas is increased.

3. The gas concentrating method according to claim 1, wherein the target gas is carbon dioxide and the raw material is the atmosphere.

4. The gas concentrating method according to claim 2, wherein the target gas is carbon dioxide and the raw material is the atmosphere.

5. A gas concentrating device which concentrates a target gas, comprising:
a gas separating membrane module including a gas separating membrane and an accommodating container, a gas supply line through which a first mixed gas containing a target gas is supplied to the gas separating membrane module, a gas recovery line through which a second mixed gas containing a target gas is taken out from the gas separating membrane module, a gas discharge line through which an exhaust gas is discharged from the gas separating membrane module, and a raw material line through which a raw material is supplied to the gas supply line,
wherein the raw material through the raw material line and the second mixed gas through the gas recovery line are supplied to the gas supply line.

6. The gas concentrating device according to claim 5, further comprising:
a monitoring device which monitors an amount of supply A [mL/min] of the first mixed gas and a target gas concentration X [mol %] in the first mixed gas and an amount of generation B [mL/min] of the second mixed gas and a target gas concentration Y [mol %] in the second mixed gas over time; and
a flow rate control device which controls an amount of supply of the first mixed gas,
wherein, if a rate of change in target gas concentration in the second mixed gas is less than or equal to a prescribed value, an instruction is given to decrease the amount of supply of the first mixed gas in the second step.

7. The gas concentrating device according to claim 5, wherein the target gas is carbon dioxide and the raw material is the atmosphere.

8. The gas concentrating device according to claim 6, wherein the target gas is carbon dioxide and the raw material is the atmosphere.
